(19) United States
(12) Patent Application Publication
(10) Pub. No.: US 2024/0326244 A1
(43) Pub. Date: Oct. 3, 2024

(54) CONTROL OF ROBOTIC ARM AND END EFFECTOR VIA VIRTUAL FORCE SENSING

(71) Applicant: Omron Corporation, Kyoto (JP)

(72) Inventors: Siddharth Sanan, San Ramon, CA (US); Andres Rodriguez Campo, San Ramon, CA (US); Sean Bailey, San Ramon, CA (US); John Drinkard, San Ramon, CA (US)

(21) Appl. No.: 18/128,364

(22) Filed: Mar. 30, 2023

(51) Int. Cl. B25J 9/16; B25J 13/08

(52) U.S. Cl. CPC B25J 9/1633; B25J 9/163; B25J 13/084

(57) ABSTRACT

Methods and systems are described for determining the contact state of a robotic arm and the contact forces between the robotic arm and its environment, without the use of additional add-on sensors, such force or torque sensors. One or more embodiments involve initiating response actions of the robot arm based on the inferred contact state or contact force, to execute a desired application. Example response actions include actuation of an end effector of the robotic arm, such as for object placement.

### TECHNICAL FIELD

The present invention generally relates to robotic arms, and particularly relates to control of robotic arms based on virtual force sensing.

### BACKGROUND

Robotic arms perform various tasks across a range of industries, with contact sensing being an important aspect of robot operation from the perspectives of both safety and task performance. For example, a robotic arm includes an end effector by which it grasps parts or other items for placement in a container or on working surface. In addition to the need for detecting when a part carried by the robotic arm contacts a surface for placement, there may be safety considerations that require detecting contact of the robotic arm with essentially any external object during its movement.

Machine vision represents one option for controlling the robotic arm in terms of safety and task operations. For example, one or more cameras image the working area of the robotic arm, with image processing used to estimate the position of the robotic arm in three-dimensional (3D) space in real time or near real time. Machine vision may be too expensive in certain applications or may be unsuited in terms of accuracy for certain applications.

Use of physical contact or force sensors on the robotic arm or its end effector stands as an obvious solution to the contact-sensing problem, but the solution is impractical for robotic arms not originally designed to include such sensors. Further, adding force or torque sensors to robotic arms or their end effectors necessarily introduces added, potentially significant costs, and presents challenges with respect to initial and ongoing calibration requirements.

Virtual or inferential force sensing stands as another option for detecting arm or effector contact. Rather than instrumenting a robotic arm with force sensors, such as dedicated torque sensors at each of the joints in the robotic arm, virtual force sensing provides for collision or contact detection without the use of dedicated force sensors. For example, some approaches to virtual force sensing estimate the torque at joints along the robotic arm, as a basis for detecting when the arm contacts an object in its working space. As one example, see Pengfei Cao, Yahui Gan, and Xianzhong Dai, “Model-based sensorless robot collision detection under model uncertainties with a fast dynamics identification.” International Journal of Advanced Robotic Systems, Vol. 16, Issue 3, May-June 2019.

While offering meaningful economical and practical advantages, the use of virtual force sensing brings with it many challenges. Among those challenges are achieving acceptable reliability and accuracy and limiting the need for manual tuning of the parameter thresholds related to contact state estimation.

### SUMMARY

Methods and systems are described for determining the contact state of a robotic arm and the contact forces between the robotic arm and its environment, without the use of additional add-on sensors, such as force or torque sensors. One or more embodiments involve initiating response actions of the robot arm based on the inferred contact state or contact force, to execute a desired application. Example response actions include actuation of an end effector of the robotic arm, such as for object placement.

An example embodiment comprises a method performed by an electronic control system. The method includes: (a) generating torque commands for actuating a robotic arm, each torque command indicating a commanded torque for a corresponding joint actuator at a respective joint of the robotic arm the commanded torque dependent on a presence or absence of an interfering external contact force; (b) predicting an expected torque with respect to each commanded torque, such that there are corresponding pairs of commanded and expected torques, with the predicting presuming the absence of interfering external contact forces; (c) performing contact force detection during actuation of the robotic arm, by evaluating residual values against corresponding thresholds that account for prediction noise associated with predicting the expected torques; and (d) controlling an end effector of the robotic arm responsive to the contact force detection.

Another example embodiment comprises an electronic control system configured to control actuation of a robotic arm. The electronic control system includes: (a) interface circuitry configured to interface the electronic control system with the robotic arm; and (b) processing circuitry operatively associated with the interface circuitry and configured to: (i) generate torque commands for actuating the robotic arm, each torque command indicating a commanded torque for a corresponding joint actuator at a respective joint of the robotic arm, the commanded torque dependent on a presence or absence of an interfering external contact force; (ii) predict an expected torque with respect to each commanded torque, such that there are corresponding pairs of commanded and expected torques, with the predicting presuming the absence of interfering external contact forces; (iii) perform contact force detection during actuation of the robotic arm, by evaluating residual values against corresponding thresholds that account for prediction noise associated with predicting the expected torques; and (iv) control an end effector of the robotic arm responsive to the contact force detection.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of a robot system according to an example embodiment, including a robotic arm and an electronic control system configured to control actuation of the robotic arm based at least in part on virtual force sensing.

FIG. 2 is a block diagram of an example actuator, as may be used at respective joints of a robotic arm.

FIG. 3 is a block diagram of example details for the processing circuitry introduced in FIG. 1.

FIGS. 4 and 5 are block diagrams, illustrating example motions of a robotic arm that are controlled or otherwise modified in dependence on virtual force sensing.

FIGS. 6 and 7 are logic flow diagrams illustrate methods of virtual force sensing by an electronic control system with respect to a robotic arm, according to example embodiments.

FIG. 8 is a functional diagram of a virtual force sensor for contact-state classification, as may be instantiated in an electronic control system, according to an example embodiment.

FIG. 9 is a block diagram of an example application flow, including end-effector control based on virtual force sensing.

FIG. 10 is a block diagram of a contact-state classification module, as may be instantiated in an electronic control system, according to an example embodiment.

FIG. 11 is a diagram of example velocity-dependent thresholds, as may be used for contact-state classification, according to an example embodiment.

FIG. 12 is a block diagram illustrating functional processing as may be instantiated in an electronic control system, for determining undetectable contact force in the context of virtual force sensing.

### DETAILED DESCRIPTION

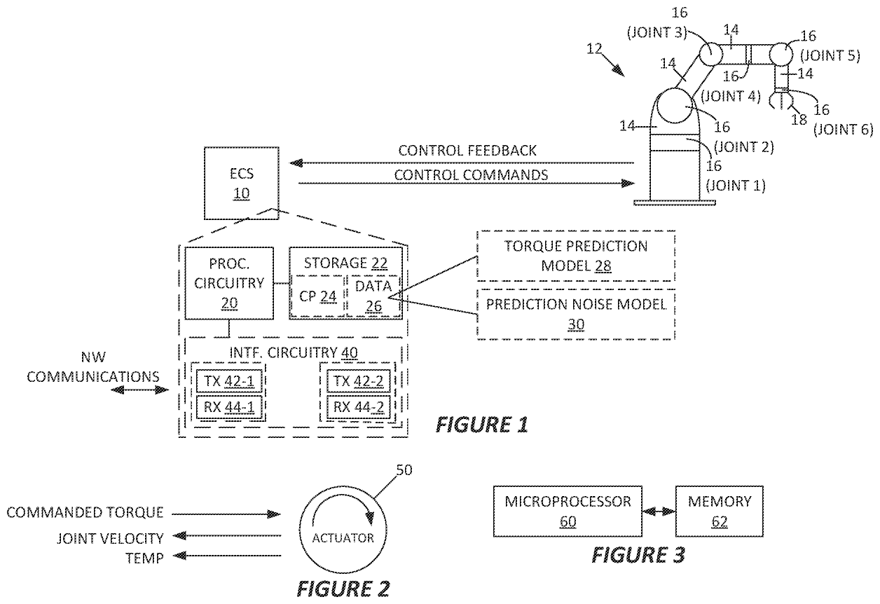

FIG. 1 illustrates an electronic control system (ECS) 10 according to an example embodiment. Control commands output by the ECS 10 control actuation of a robotic arm 12, which comprises a number of links 14, with respective interconnecting joints 16. Coordinating rotational direction, amount, and speed of the respective joints 16 determines movement of the robotic arm 12 within its surrounding physical environment, including positioning of an end effector 18 of the robotic arm 12 within the environment.

An advantageous aspect of the ECS 10 is its configuration for control of the robotic arm 12 and the end effector 18, based on virtual force sensing according to techniques that achieve acceptable reliability and accuracy and limit the need for manual tuning of the parameter thresholds related to virtual force sensing and corresponding contact state estimation. To these ends, the ECS 10 includes appropriately configured processing circuitry, interface circuitry. In one or more embodiments, the ECS 10 stores data comprising prediction models and uses such models in its virtual-force sensing.

According to the illustrated example, the ECS 10 includes processing circuitry 20, which may include or be communicatively coupled with storage 22. In one or more embodiments, the storage 22 stores one or more computer programs 24 (“CP” in the diagram), along with one or more types of data 26. In at least one embodiment, the stored data 26 includes a torque prediction model 28 and a prediction noise model 30. The term “model” refers to one or more algorithms representing a simplified version of a real-world process, with the algorithm(s) predicting values of dependent variables-output variables-based on rules relating the output variables to input variables reflecting real-world measurements or data.

Interface circuitry 40 of the ECS 10 provides communicative coupling of the processing circuitry 20 with one or more external entities, systems, or devices. For example, the interface circuitry 40 includes first transceiver circuitry-shown as a transmitter (TX) 42-1 and a receiver (RX) 44-1—for interfacing with a Local Area Network (LAN) or other data network. A non-limiting example is implementation of the TX 42-1 and RX 44-1 as Ethernet-based interface circuitry. Of course, such circuitry may be radio circuitry for wireless communications, as an alternative or addition to wired connectivity.

The illustrated interface circuitry 40 further includes second transceiver circuitry-shown as a transmitter (TX) 42-2 and a receiver (RX) 44-2—for interfacing with the robotic arm. Such circuitry may comprise digital or analog signaling circuitry or both, for outputting control commands to the robotic arm 12 and receiving feedback from the robotic arm 12. While FIG. 1 suggests implementation of the ECS 10 in standalone fashion from the robotic arm 12, other embodiments involve integration of the ECS 10 within the robotic arm 12, and the nature of the interface circuitry 30 may change, depending on whether or to what extent the robotic arm 12 integrates the ECS 10.

FIG. 2 illustrates example signaling between the ECS 10 and an actuator 50 associated with a given joint 16 of the robotic arm 12. The actuator 50 comprises a Direct Current (DC) rotary actuator, for example, but the robotic arm 12 in one or more embodiments may include linear actuators or a mix of linear and rotary actuators. In any case, the example actuator 50 responds to incoming commands that control, for example, the direction of joint actuation, the actuation speed, and the extent of actuation. For rotary motion, such commands drive changes in joint angle, and controlling joint angles across/between the respective links 14 of the robotic arm 12 determines the pose of the robotic arm 12 within space and the path of motion taken by the robotic arm 12 through that space.

Actuation of the robotic arm 12 occurs in relation to execution of an “application,” for example. The application is embodied as a computer program, for example, and defines certain motions and end-effector operations to be performed by the robotic arm 12, to perform one or more tasks. Example tasks include pick-and-placement tasks, where the robotic arm 12 picks up an item from one location and places it in another location. In one example application, the robotic arm 12 retrieves items from a conveyor and sequentially “packs” them on a pallet, in a box, or the like.

The ECS 10 may execute computer programs embodying applications. Likewise, the virtual force sensing and related control operations of interest in this disclosure may be realized at least in part via the execution of stored computer program instructions. FIG. 3 provides a corresponding example implementation of the processing circuitry 20 and storage 22.

In the example implementation, the processing circuitry 20 is realized based on a microprocessor 60 executing computer program instructions held in an associated memory 62. In other words, the microprocessor 60 is specially adapted to operate according to the processing-circuitry descriptions provided herein, based on executing computer program instructions.

More generally, the processing circuitry 20 may be realized as fixed circuitry, programmatically configured circuitry, or a mix of both. Moreover, rather than a single microprocessor, two or more microprocessors may be used, or a multi-core microprocessor may be used. Additionally, or alternatively, implementation of the processing circuitry 20 may be based on essentially any type of digital processing circuitry, such as one more Field Programmable Gate Arrays (FPGAs), System-on-Chip (SoC), Application Specific Integrated Circuits (ASICs), Complex Programmable Logic Devices (CPLDs), or Digital Signal Processors (DSPs).

The storage 22 may comprise one or more types of computer-readable media, including volatile memory as working memory for program execution and related data storage, and non-volatile memory for longer-term storage of computer programs and configuration data, such as one or more user-configured parameter values. Examples, include Dynamic Random Access Memory (DRAM), Static RAM (SRAM). Non-volatile RAM (NV-RAM), FLASH or Solid State Disk (SSD), Electrically Erasable Programmable Read-only Memory (EEPROM), etc.

Regardless of specific implementation details, the ECS 10 is configured to control actuation of a robotic arm 12, based on having interface circuitry 40 that is configured to interface the ECS 10 with the robotic arm 12 and further based on having processing circuitry 20 that is operatively associated with the interface circuitry 40 and configured to perform certain operations that realize virtual contact force sensing for the robotic arm 12 in an advantageous manner. Referring to the processing circuitry 20 as being “operatively associated with” the interface circuitry 40 means that the processing circuitry 20 uses or relies on the interface circuitry 40 for sending and receiving information, such as sending control commands to actuators 50, and receiving temperature and/or velocity information from the actuators 50.

The certain operations associated with the advantageous virtual force sensing and related control of the robotic arm 12 in one or more embodiments include: (1) generate torque commands for actuating the robotic arm 12, each torque command indicating a commanded torque for a corresponding joint actuator 50 at a respective joint 16 of the robotic arm 12, the commanded torque dependent on a presence or absence of an interfering external contact force; (2) predict an expected torque with respect to each commanded torque, such that there are corresponding pairs of commanded and expected torques, with the predicting presuming the absence of interfering external contact forces; (3) perform contact force detection during actuation of the robotic arm 12, by evaluating residual values against corresponding thresholds that account for prediction noise associated with predicting the expected torques; and (5) control the end effector 18 of the robotic arm responsive to the contact force detection.

The processing circuitry 20 in one or more embodiments is configured to output alert signaling or activating an alert indicator, responsive to determining that the prediction noise results in an undetectable contact force that exceeds a programmed threshold. For example, the processing circuitry 20 outputs alert signaling as a data packet via its network interface.

The processing circuitry 20 in one or more embodiments is configured to terminate or modify the actuation of the robotic arm 12 in response to the contact force detection indicating contact between the robotic arm 12 and an external object.

In at least one embodiment, to perform the contact force detection and with respect to each residual value, the processing circuitry 20 is configured to classify the robotic arm 12 as being in either a contact state or a no-contact state, in dependence on whether the residual value exceeds a threshold that depends on the prediction noise. In one or more such embodiments, the processing circuitry 20 is further configured to initiate stoppage of the actuation of the robotic arm 12 in response to the classifying indicating transition of the robotic arm 12 from the no-contact state to the contact state.

The prediction noise is velocity dependent in one or more embodiments, such that the threshold used by the processing circuitry 20 for each residual value depends on a joint velocity of the respective joint 16 at a time corresponding to prediction of the expected torque on which the residual value is based. The processing circuitry 20 in one or more embodiments is configured to compute the prediction noise as a function of static friction, for joint velocities below a defined velocity threshold, and as a function of quantified modeling uncertainties in a torque prediction model 28 used by the ECS 10, for joint velocities above the defined velocity threshold. Rather than having a discrete switchover at the velocity threshold, the processing circuitry in one or more embodiments is configured to blend the two noise prediction models.

Further, in at least one embodiment, the processing circuitry 20 is configured to maintain an estimate of a maximum undetectable contact force associated with performing the contact force detection. Here, the processing circuitry 20 is configured to compute the estimate as a function of the prediction noise and output signaling indicating the estimate or indicating that the estimate exceeds a defined contact force threshold or indicating both. In at least one example in this context, the processing circuitry 20 is configured to set the defined contact force threshold according to a user-configured value. For example, the ECS 10 is configured to receive user-configuration information over its network interface.

The processing circuitry 20 in one or more embodiments is configured to determine the prediction noise according to a prediction noise model 30 corresponding to a torque prediction model 28 used by the ECS 10 to predict the expected torques. For predicting the expected torque with respect to each commanded torque, the processing circuitry is configured to receive joint angle and velocity information during the actuation of the robotic arm and correspondingly predict expected torques.

Further, for predicting the expected torque with respect to each commanded torque, the processing circuitry 20 in one or more embodiments is configured to account for one or more of: gravity-related torque at the respective joint; or friction-related torque at the respective joint. Particularly, to account for the friction-related torque at a respective joint, the processing circuitry 20 in one or more embodiments is configured to use a temperature-related model for the friction-related torque, based on receiving velocity information and operating temperature information for the respective joint. For a rotational joint, the joint velocity is angular velocity.

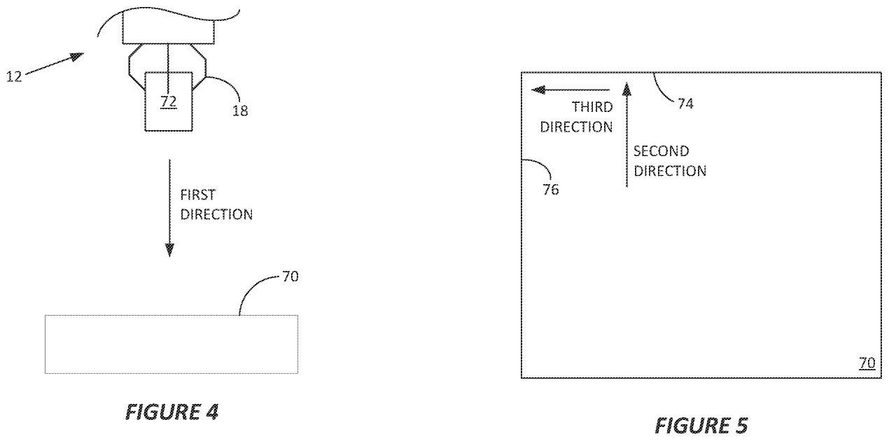

Example actuation of the robotic arm 12 by the ECS 10 involves, as suggested in FIG. 4, at least a first movement of the robotic arm 12, in which the robotic arm 12 moves the end effector 18 in a first direction that is normal to and towards a placement surface 70. With respect to performing the contact force detection, the processing circuitry 20 is configured to detect contact while moving the robotic arm 12 in the first direction and terminate the first movement responsive to detecting the contact. Such movement involves, for example, placing an object 72 on the placement surface 70. Correspondingly, in one or more embodiments, the processing circuitry 20 is configured to control the end effector 18 responsive to the contact force detection by controlling the end effector 18 to release the object 72. That is, the ECS 10 controls the robotic arm 12 such that the end effector 18 releases the object, responsive to the ECS 10 detecting the contact in the first direction.

FIG. 5 illustrates additional operations that may be performed in an example application. Rather than releasing the object 72 upon detecting contact in the first direction, the ECS 10 terminates movement by the robotic arm 12 in the first direction, responsive to detecting the object 72 contacting the placement surface 70, with the overall actuation then involving a second movement in which the robotic arm 12 moves the end effector 18 in a plane parallel to the placement surface 70. The second movement thus is in a second direction in the parallel plane, and, with respect to performing the contact force detection, the processing circuitry 20 is configured to detect contact while moving the robotic arm 12 in the second direction and terminate the second movement responsive to detecting the contact in the second direction.

The processing circuitry 20 may be configured to control the end effector 18 to release the object 72 responsive to detecting the contact in the second direction. Such operations allow the robotic arm 12 to move the object 72 along the placement surface 70 until it contacts another surface 74, such as a previously placed object, for example, or the wall or side of a box or container into which objects 72 are being packed.

In an extension of the foregoing packing movements, the actuation further involves a third movement performed responsive to termination of the second movement. In the third movement, the robotic arm 12 also moves the end effector 18 in the parallel plane, but in a third direction that is at an angle relative to the second direction, with the processing circuitry 20 being configured to detect contact while moving the robotic arm in the third direction and terminate the third movement responsive to detecting the contact in the third direction, e.g., with a surface 76, which may be another object or a container wall. Correspondingly, the processing circuitry 20 may be configured to control the end effector 18 to release the object 72 responsive to termination of the third movement. Such operations allow for X-Y movements, or movements at other angles, in a directional plane parallel to the placement surface 70, for packing multiple objects 72 into a container or forming stacked layers of placed objects 72.

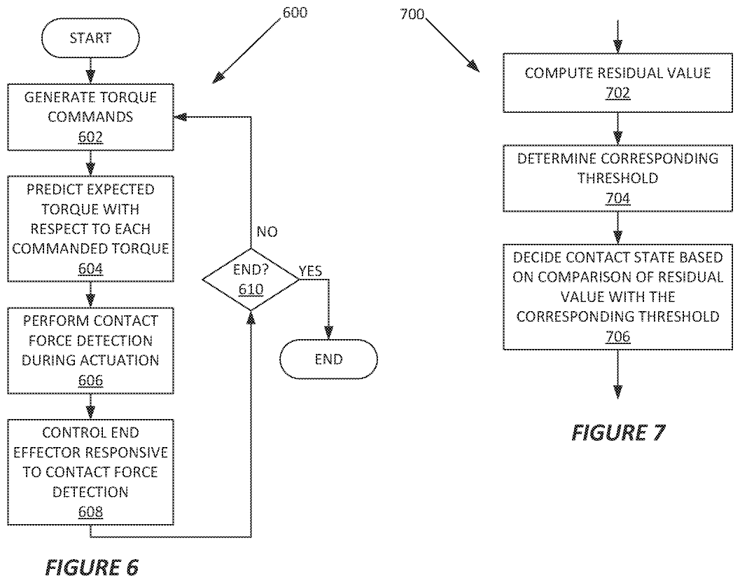

FIG. 6 depicts a method 600 of operation by an ECS, such as the ECS 10 described above. The method 600 includes: generating (Block 602) torque commands for actuating a robotic arm 12, each torque command indicating a commanded torque for a corresponding joint actuator 50 at a respective joint 16 of the robotic arm 12, the commanded torque dependent on a presence or absence of an interfering external contact force; predicting (Block 604) an expected torque with respect to each commanded torque, such that there are corresponding pairs of commanded and expected torques, with the predicting presuming the absence of interfering external contact forces; performing (Block 606) contact force detection during actuation of the robotic arm 12, by evaluating residual values against corresponding thresholds that account for prediction noise associated with predicting the expected torques; and controlling (Block 608) an end effector of the robotic arm responsive to the contact force detection.

Broadly, the method 600 may include any of the operations described above for the processing circuitry 20 of the example ECS 10, and it may repeat during ongoing execution unless the ECS decides to end actuation (YES from Block 610). For example, the method 600 ends upon completion of the actuation or upon detecting a transition of the robotic arm 12 transitioning from the non-contact state to the contact state. NO from Block 610 means that ongoing processing continues with generation of torque commands.

FIG. 7 illustrates example details for comparing a commanded torque with an expected torque. The example method 700 includes computing (Block 702) a residual value between the commanded torque and the corresponding expected torque, determine (Block 704) a corresponding threshold for evaluating the residual value, where the threshold may be velocity-dependent, and decide (Block 706) the contact state of the robotic arm 12, based on the comparison of the residual value with the threshold.

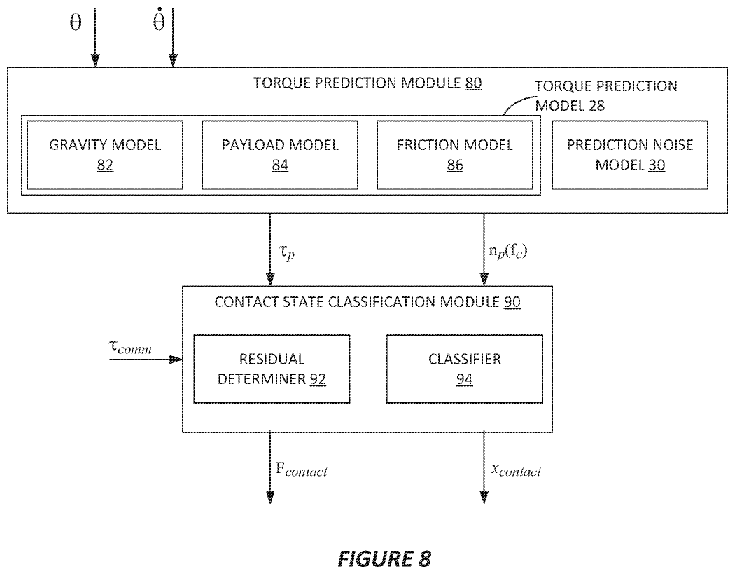

FIG. 8 depicts primary functional modules of the ECS 10, according to an example embodiment. “Module” or “processing unit” refers to a logical function or collection of functions that compute output values or decisions based on one or more input values or decisions used by the module, with such functionality instantiated via underlying processing circuitry.

Primary modules include a torque prediction module 80, which predicts expected torques, shown as τₚ, in the diagram, corresponding to commanded torques, based on use of the torque prediction model 28 and the prediction noise model 30. The torque prediction model 28 in this example models multiple effects on the expected torque to move a particular joint, based on including a gravity-related torque model 82, a payload-related torque model 84, and a friction-related torque model 86.

The torque prediction module 80 predicts the expected torque at each joint 16 of the robotic arm 12, on the assumption of no contact and based on known or learned models of the robotic arm 12. A contact state classification module 90 includes a residual determiner 92 and a classifier 94 and it outputs estimated contact force, F_{contact}, and the estimated contact state of the robotic arm 12, shown as x_{contact}. These determinations are made with respect to expected torque, τₚ, the commanded torque, τ_{comm}, and the prediction noise, nₚ(f_{c}), as determined according to the prediction noise model 30. Here, f_{c} is a vector containing the coulomb friction parameters for the respective joints.

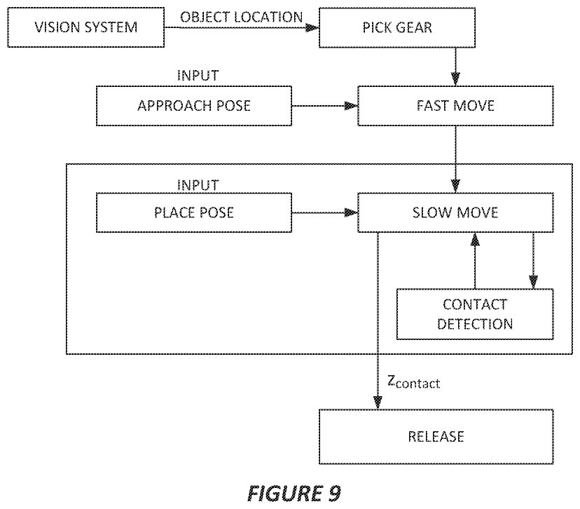

FIG. 9 depicts an example application for the robotic arm 12, such as may be executed by the ECS 10. The application utilizes the contact state information determined by the ECS 10 via virtual force sensing. Particularly, the contact state information is used during a slow move phase of the application when the robotic arm 12 has contacted a placement surface for corresponding initiation of end-effector control for release of a part from the end effector 18 of the robotic arm 12.

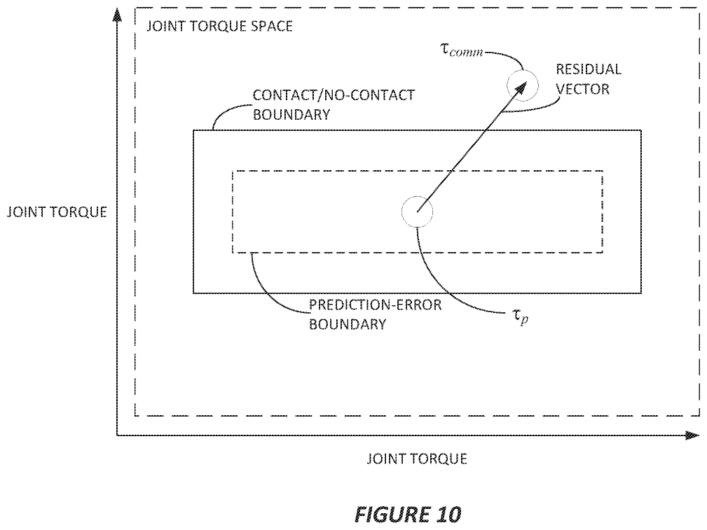

FIG. 10 illustrates evaluation of residual values according to an example embodiment. Taking the difference between a commanded torque, τ_{comm}, and the corresponding expected torque, τₚ, yields a residual vector, which may be generally referred to as a residual value. That is, the commanded torques and the corresponding predicted torques may comprise numerical values, with the differences therebetween being residual values.

FIG. 10 illustrates a prediction-error boundary defined by the prediction noise, nₚ(f_{c}), with this boundary representing the maximum undetectable force associated with virtual force sensing. The contact decision boundary is constructed such that the torque prediction error is always inside the contact decision boundary. The prediction error has a number of sources of noise and is dependent on the physical properties of the robotic arm 12, like the coulomb friction at the respective joints 16. Thus, for each of one or more respective joints 16 of the robotic arm, a residual value may be computed for each commanded torque for the actuator 50 at the respective joint 16, by taking the difference between the commanded torque and the corresponding predicted torque. Such operations may be performed on an ongoing basis, with respect to each of one or more joints 16 of the robotic arm, during actuation of the robotic arm 12 according to a running application.

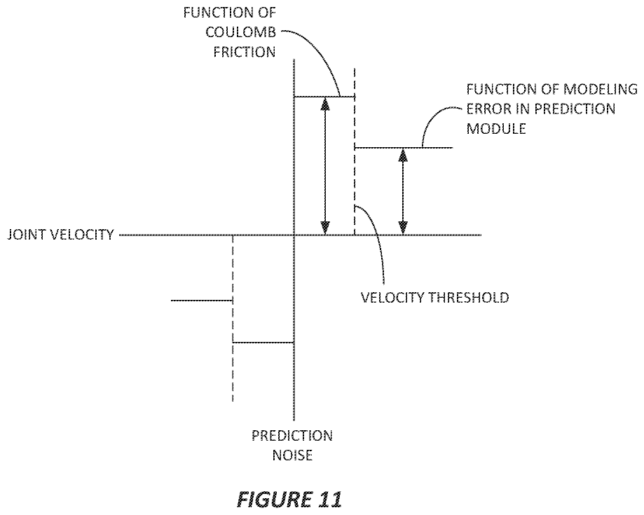

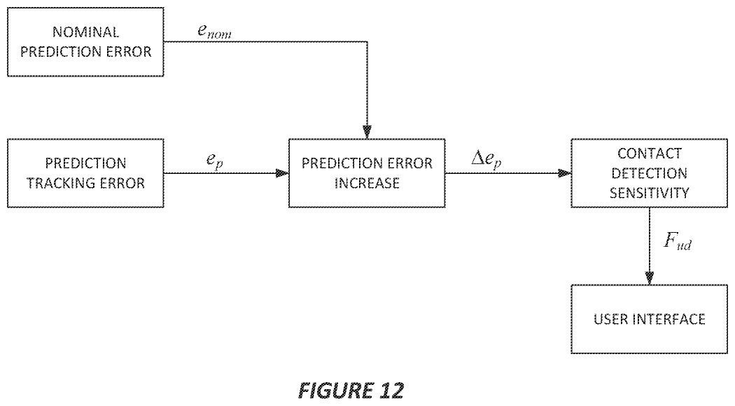

FIG. 11 illustrates the dependence of prediction noise on physical properties of the robotic arm 12 like coulomb friction as well as joint velocity. At lower joint velocities (below a defined velocity threshold), the noise is dominated by coulomb friction. However, at higher joint velocities (at or above the defined velocity threshold), the noise is largely a function of modeling errors in the torque prediction module 80. The coulomb friction results in a fundamental lower bound on the prediction noise at joint velocities that are close to zero

With the above example details in mind, one method of virtual force detection according to disclosed techniques consists of a model-based algorithm for detecting when the end effector 18 of a robotic arm 12 is in contact with an external object and detecting or otherwise estimating the contact forces. The algorithm uses a model to predict expected torques during motion of the robot and compares this prediction with the torques being commanded by the control system. The contact state and contact forces of the robot are inferred based on the discrepancy between the expected and commanded torques. Additional example details appear below, with emphasis on two main algorithmic components: (1) a Predictive Torque Model and, (2) a Contact State Classifier.

### Torque Prediction Model

The torque prediction model aims to compute the torque, r required for any configuration, θ, for quasi-static motion of the robot, assuming the robot is not in contact. The predictive model consists of a gravitational model that computes torques at the joints due to gravity and a friction model that estimates torque due to friction at the joint. Torque due to acceleration and Coriolis forces is not included in this example embodiment but can be included in other embodiments especially when application speeds are expected to be high. These components are described next.

### Torque Prediction Model—Gravitational Model

The gravitational model computes the gravitational torques, τ_{g} for the joints of the robot. The gravitational model can be derived from:
1. a physics-based model of the robot from the CAD data,
2. learning a non-parametric model of the gravitation torques, and
3. learning a parametric model of the gravitational torques.

In the example embodiment, the gravitational model is derived by learning a parametric model because it provides a balance of generalizability (due to the parametric nature of the model) and accuracy (due to model being derived from real-world data). The process of learning a parametric gravitational model is described in the next paragraphs.

For learning the gravitational model, one may represent the gravitational torques in the robotic arm 12 using a two degree of freedom (2 DoF) model consisting of Joint 2 and Joint 3 since the gravitational torques on the remaining joints is negligible compared to frictional effects. Using this model, the gravitational torques can be written as:

$${τ}_{g} = A ( θ ) p ( r , l ) \qquad Eq . 1$$

$${τ}_{g} = A ( θ ) p ( r , l ) \qquad Eq . 2$$

where τ_{g}∈R² is gravitational torque, θ∈S² defines the configuration of the model, r∈R⁴ provides the location of the center of mass of each link 14 in the plane of the model and l∈R² is the vector of link lengths of the model. A is a linear operator A: R^{m}→R² that maps the parameter vector p∈R^{m} to the torque vector τ_{g} where m is the number of parameters.

The goal of learning a parametric gravitational model is to generate an estimate of the parameters from n observations of the torque and robot configuration. This estimation can be carried out using standard linear regression. For the 2 DoF model used to represent the robotic arm 12. A(θ) and p are given by the following equations:

$$A = ( \begin{matrix}cos ( {θ}_{1} ) & sin ( {θ}_{1} ) & cos ( {θ}_{1} + {θ}_{2} ) & sin ( {θ}_{1} + {θ}_{2} ) \\ 0 & 0 & cos ( {θ}_{1} + {θ}_{2} ) & sin ( {θ}_{1} + {θ}_{2} )\end{matrix} ) \qquad Eq . 3$$

$$p = ( \begin{matrix}{m}_{1} {r}_{1 x} g + {m}_{2} {l}_{1 g} \\ - {m}_{1} {r}_{1 y} g \\ {m}_{2} {r}_{2 x} g \\ - {m}_{2} {r}_{2 y} g\end{matrix} ) \qquad Eq . 4$$

Note that it is not necessary to know the form of the parameters, p in Eq. 4. These are provided for the sake of completeness. As stated, τ_{g} ∈R², however the actual torques on the robotic arm 12 are elements in R⁶, in an example scenario where the robotic arm 12 has 6 DoF. The gravitational torques are lifted into R⁶ as τ_{g}=[0,τ_{g1},τ_{g2},0,0,0,0] for further computations. For the sake of notational brevity, one may overload the symbol τ_{g} to denote the lifted gravitational torque vector.

For learning the gravity model, the robotic arm 12 is moved continuously between configurations with small positive and negative joint velocities. The joint torque averaged over the positive and negative joint velocities is used as training data to estimate the model in Eq. 1.

### Torque Prediction Model—Friction Model

The friction at each joint 16 is typically difficult to accurately characterize due to the relatively complicated physical phenomena associated with it. For instance, friction can depend on the temperature conditions at the contact site, the lubricants used, the wear condition of the joint 16 and/or the overall system, etc. Some of these parameters are often difficult to directly observe and hence make it difficult to determine a model that generalizes well across systems. A practical compromise is to use a coulomb plus viscous friction model that is estimated from data. The friction torque τ_{fi} at joint i is computed as:

$${τ}_{fi} = {f}_{ci} sgn ( {\dot{θ}}_{i} ) + {f}_{vi} {\dot{θ}}_{i} \qquad Eq . 5$$

where, f_{ci} is the coulomb friction parameter at joint i and sgn(.) is the signum function, fᵥᵢ is the viscous friction at the joint and \dot{θ} is the joint velocity. Training data is similar to that used for estimating the gravitational model. Details of the estimation procedure are provided in the next sub section. Temperature-related effects on friction and strategies to address them are also discussed in the next sub section.

### Friction Model—Joint Friction Estimation Procedure

The coulomb and friction parameters of the joint are estimated offline using the following procedure:
1) Move the robotic arm 12 along a trajectory such that all joint velocities are positive and constant, i.e., \dot{θ}=vⱼ. Collect joint angle (θ) and positive commanded torque data, τₚₒₛ.
2) Move the robotic arm 12 along the same trajectory as step 1 but in the opposite direction so that all joint velocities are negative and constant, i.e., \dot{θ}=−vⱼ. Collect joint angle (θ) and negative commanded torque data, τ_{neg}.
3) For joint velocity \dot{θ}=vⱼ, compute estimated friction by computing the difference in torques from step 1 and step 2 for each joint (i) at every joint angle in the data set Eq. 6. Compute mean of estimated friction over all joint angles Eq. 7.
4) Use friction computed using Eq. 7 as training data to estimate the model in Eq. 5:

$${f}_{i} ( θ \vert \dot{θ} = {v}_{j} ) = 0.5 ( {τ}_{{i}_{pos}} ( θ ) + {τ}_{{i}_{neg}} ( θ ) ) \qquad Eq . 6$$

$${\hat{f}}_{i} ( {v}_{j} ) = {mean}_{θ} ( {f}_{i} ( θ ) ) \qquad Eq . 7$$

Because temperature is expected to significantly vary friction at the joints, the above procedure is repeated for multiple ambient temperatures, Tₐ in the operating temperature range of the robotic arm 12. This is or can be done by placing the robotic arm 12 in a temperature chamber that allows the ambient temperature to be varied. Data from all temperatures is used to estimate coulomb friction temperature dependence

$$( \frac{\partial {f}_{c}}{\partial {T}_{a}} )$$

and viscous friction temperature dependence

$$( \frac{\partial {f}_{v}}{\partial {T}_{a}} ) .$$

The friction parameters at any operating temperature (Tₒₚ) can then be computed as:

$${f}_{ci} ( {T}_{op} ) = {f}_{ci} ( {T}_{calib} ) + ( \frac{\partial {f}_{ci}}{\partial {T}_{a}} ) ( {T}_{op} - {T}_{calib} ) \qquad Eq . 8$$

$${f}_{vi} ( {T}_{op} ) = {f}_{vi} ( {T}_{calib} ) + ( \frac{\partial {f}_{vi}}{\partial {T}_{a}} ) ( {T}_{op} - {T}_{calib} ) \qquad Eq . 9$$

### Torque Prediction Model—Payload Torque Model

The function of the payload torque model is to compute the torque at the joints due to a payload—e.g., an object—being carried by the robotic arm 12. The torque model assumes knowledge of the mass of the object, mₚ and distance of payload Center of Mass (CoM) to the joint 5 (J5) axis of the robotic arm 12, rₚₓ. Consequently, the grasp configuration of the object being held by the robotic arm 12 should be known if it changes rₚₓ significantly. The model also assumes knowledge of the length of the links 16 of the robotic arm 12, l. The torque at joints 2 and 3 due to the payload is given by:

$${τ}_{pl} = {A}_{pl} ( θ ) {p}_{pl} ( l ) \qquad Eq . 10$$

where Aₚₗ and pₚₗ is given by:

$${A}_{pl} = ( \begin{matrix}cos ( {θ}_{1} ) & cos ( {θ}_{1} + {θ}_{2} ) & sin ( {θ}_{1} + {θ}_{2} ) & \begin{matrix}cos ( {θ}_{5} ) ( {θ}_{1} + {θ}_{2} ) - \\ sin ( {θ}_{5} ) sin ( {θ}_{1} + {θ}_{2} ) \\ cos ( {θ}_{4} )\end{matrix} \\ 0 & cos ( {θ}_{1} + {θ}_{2} ) & sin ( {θ}_{1} + {θ}_{2} ) & \begin{matrix}cos ( {θ}_{5} ) ( {θ}_{1} + {θ}_{2} ) - \\ sin ( {θ}_{5} ) sin ( {θ}_{1} + {θ}_{2} ) \\ cos ( {θ}_{4} )\end{matrix}\end{matrix} ) \qquad Eq . 11$$

$${p}_{pl} = ( \begin{matrix}{m}_{p} {l}_{1} g \\ {m}_{p} {l}_{2 x} g \\ - {m}_{p} {l}_{2 y} g \\ {m}_{p} {r}_{px} g\end{matrix} ) \qquad Eq . 12$$

### Prediction of Expected Torque

The expected torque at each respective joint 16, τₚ, is given by the sum of the torque computed by the gravitational model, τ_{g}, the friction torque computed by the friction model, τ_{f}, and the computed payload torque, τₚₗ, expressed as:

$${τ}_{p} = {τ}_{g} + {τ}_{f} + {τ}_{pl} \qquad Eq . 13$$

### Predicted Contact Force

The predicted contact force can be derived from the predicted torque by using the robot Jacobian for the contact location assuming the contact location. The contact location can be derived from application specific data.

$${F}_{p} = {J}_{c}^{- T} ( θ ) {τ}_{p} \qquad Eq . 14$$

Above, F_{c} is the contact force, J_{c} is the joint angle dependent contact Jacobian at the contact point (the −T superscript in the equation is notation used for the inverse of the transpose) and τₚ is the predicted torque. It should be noted that it is possible to use the above equation to transform joint torque and related quantities into contact force related quantities.

### Prediction Noise—Torque Prediction Noise

Even absent the effects of external contact forces acting on the robotic arm 12, the expected torques differ from commanded torques due to a number of sources of noise. These include errors in the gravity model, friction model, and payload model. Other sources of errors are inertial forces, Coriolis forces and the low-level joint torque controller errors. Overall, the deviation of the expected torques from the commanded torques can be represented as:

$${τ}_{p} = {τ}_{comm} + {n}_{p} \qquad Eq . 15$$

where nₚ, is the noise in the prediction due to some of the sources of error mentioned above. Ideally, nₚ should be as small as possible. However, at zero velocity, a lower bound exists for the noise at the joint and this corresponds to friction at zero velocity at the joint (f_{ci}), i.e.:

$${n}_{pi} \geq {f}_{ci} if {\dot{θ}}_{i} = 0 \qquad Eq . 16$$

where, nₚᵢ is the prediction noise, f_{ci} is the friction at joint i at zero velocity and \dot{θ}ₗ is the joint velocity, for joint i. The above lower bound f_{ci} may be referred to as the prediction noise lower bound.

### Prediction Noise—Force Prediction Noise

The force prediction noise can be computed using the contact Jacobian (J_{c}) similar to Eq. 13.

$${n}_{p}^{F} = {J}_{c}^{- T} ( θ ) {n}_{p} \qquad Eq . 17$$

The noise in the predicted contact force can be used to determine if the contact force estimation is within acceptable performance for a given application.

### Contact State Classifier—Residual Computation

The expected torques, τₚ, computed using the predictive torque model (Eq. 13) are compared against the commanded torques by the controller, τ_{comm} to compute a residual:

$${τ}_{r} = {τ}_{p} - {τ}_{comm} \qquad Eq . 18$$

The residual τᵣ∈R⁶ is used as the feature vector for the classifier described later. The commanded torques are the output of a position control loop running in the ECS 10 during actuation of the robotic arm 12.

### Contact State Classifier—Decision Boundary

The decision boundary is used to inform the classifier regarding the boundary separating the contact and non-contact states. It is used to model a priori known uncertainty regarding the actual torques applied at the joints. As noted earlier, the limiting source of uncertainty at zero velocity is due to coulomb friction at the joints. Correspondingly, one or more embodiments herein use a box model for the decision boundary:

$${b}_{i} = α ( {\dot{θ}}_{i} ) \qquad Eq . 19$$

where, bᵢ is the half length of the box along joint i. α( ) is used to construct a velocity dependent decision boundary as shown below:

$$α ( {\dot{θ}}_{i} ) = \{ \begin{matrix}{k}_{c} {f}_{ci} & if \vert {\dot{θ}}_{i} \vert < {v}_{thresh} \\ {k}_{v} {n}_{pi} & if \vert {\dot{θ}}_{i} \vert \geq {v}_{thresh}\end{matrix} \qquad Eq . 20$$

The decision boundary at joint velocities below vₜₕᵣₑₛₕ is dependent on the coulomb friction f_{ci} while at larger velocities it is dependent on the noise in the prediction module, k_{c}≥1 and kᵥ≥1 are scaling factors for the low and high velocity regions of the decision boundary.

### Contact State Classifier—Classification Decision

Referring back to FIG. 10, one sees a visualization of the classifier and the components of the contact state classifier. The classifier computes the residual vector using the expected (τₚ) and commanded torques (τ_{c}) and uses the decision boundary to classify the contact state of the robotic arm 12. For the box model, the classifier is defined as:

$$c ( {τ}_{r} ) = \{ \begin{matrix}0 & if {τ}_{ri} < {b}_{i} ∀ i \\ 1 & if ¬ ( {τ}_{ri} < {b}_{i} ∀ i )\end{matrix} \qquad Eq . 21$$

Where τᵣᵢ is the component of the residual vector τᵣ along joint i. The output of the classifier is assigned to the contact state, x_{contact}=c(τᵣ), x_{contact}=1 indicates the robotic arm 12 is in contact while x_{contact}=0 indicates the robotic arm 12 is not in contact. The larger the size of the decision boundary the lesser the ability of the algorithm to detect contact of the robotic arm 12.

### Acceptable Noise Levels

A natural question arises as to what is an acceptable noise in the torque prediction. The acceptable noise level is constrained by the maximum acceptable undetected force, F_{ud} requirement of the application or set of applications. The maximum undetected contact torque corresponding to F_{ud} is given by:

$${τ}_{ud} = abs ( {min}_{{θ}_{a}} ( {J}^{T} ( θ ) {F}_{ud} ) ) \qquad Eq . 22$$

Where, θₐ is the set of acceptable robot configurations. For satisfying the maximum undetected force requirement, the torque prediction noise should be less than τ_{ud}, i.e.:

$${n}_{p} < {τ}_{ud} \qquad Eq . 23$$

In practice, τ_{ud} can be determined by considering the minimum moment arm (r_min) within the feasible set of configurations for the target application. The torque at the joint due to the maximum undetected force can then be computed and provides a basis for the maximum undetected torque value. As an example, for an application with acceptable undetected force, F_{ud}=30 N and rₘᵢₙ=0.3 m, the acceptable undetected torque requirement can be computed to be ≈10 Nm.

Among the various advantages of the virtual force sensing illustrated in the above examples is that the torque prediction model 28 may be derived from analytical equations or learned from data using regression techniques. The predictive model can be composed of multiple models that infer torques at the joint due to gravity, inertia, payload, and friction. The friction model can include the use of one or more temperature inputs, e.g., an ambient temperature, joint temperature input, to compute the friction-related torques at the joint. Further a prediction noise model is associated with the predictive torque model. This noise model is dependent on physical parameters of the system like static friction at the joints.

The joint torques from the predictive model are compared with the commanded torques at the joints to generate a residual torque vector, also referred to herein as a residual vector or simply a residual value. The classifier takes as input the residual vector and the prediction noise model and outputs the estimated contact forces, contact state of the robot and associated uncertainties (also referred to as noise).

The prediction noise model accounts for deviations in the predicted torque and commanded torque due to various factors that include model-related uncertainties (e.g. gravity model variations, friction model variations) and physics-based fundamental uncertainties due to static friction at the joints. The prediction noise model is parameterized as a function of the joint velocities. At close to zero joint velocities, the prediction noise is a function of the static friction at the joints while at higher velocities the prediction noise is a function of model-related uncertainties. The two independent modes of prediction noise can be combined by discrete switching at a threshold velocity or can be blended into a single smooth function.

Example methods also allow for a user or a supervisory system to be notified if the performance of the contact force estimation or contact state estimation process varies significantly enough (based on the prediction noise model) to impact the application objective. User and or supervisory action can then involve process changes (e.g., slowing down the robot) and/or recalibration of the robot system (e.g., re-estimation of friction parameters) such that performance parameters are acceptable for the application.

With the foregoing examples in mind, the technique(s) disclosed herein enable, for example, applications that might only need contact-state information or low accuracy contact force information for meeting application objectives. For such applications conventional solutions like end-effector mounted contact force sensors can be prohibitively expensive, making the disclosed techniques a particularly attractive alternative.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method performed by an electronic control system, the method comprising:
generating torque commands for actuating a robotic arm, each torque command indicating a commanded torque for a corresponding joint actuator at a respective joint of the robotic arm, the commanded torque dependent on a presence or absence of an interfering external contact force;
predicting an expected torque with respect to each commanded torque, such that there are corresponding pairs of commanded and expected torques, with the predicting presuming the absence of interfering external contact forces;
performing contact force detection during actuation of the robotic arm, by evaluating residual values against corresponding thresholds that account for prediction noise associated with predicting the expected torques; and
controlling an end effector of the robotic arm responsive to the contact force detection.

2. The method according to claim 1, further comprising the electronic control system outputting alert signaling or activating an alert indicator, responsive to determining that the prediction noise results in an undetectable contact force exceed a programmed threshold.

3. The method according to claim 1, further comprising terminating or modifying the actuation of the robotic arm in response to the contact force detection indicating contact between the robotic arm and an external object.

4. The method according to claim 1, wherein performing contact force detection comprises, with respect to each residual value, classifying the robotic arm as being in either a contact state or a no-contact state, in dependence on whether the residual value exceeds a threshold that depends on the prediction noise.

5. The method according to claim 1, further comprising initiating stoppage of the actuation of the robotic arm in response to the classifying indicating transition of the robotic arm from the no-contact state to the contact state.

6. The method according to claim 4, wherein the prediction noise is velocity dependent, such that the threshold used for each residual value depends on a joint velocity of the respective joint at a time corresponding to prediction of the expected torque on which the residual value is based.

7. The method according to claim 6, further comprising computing the prediction noise as a function of static friction, for joint velocities below a defined velocity threshold, and as a function of quantified modeling uncertainties in a torque prediction model used by the electronic control system, for joint velocities above the defined velocity threshold.

8. The method according to claim 1, further comprising maintaining an estimate of a maximum undetectable contact force associated with performing the contact force detection, the estimate computed as a function of the prediction noise, and performing at least one of:
outputting signaling indicating the estimate; or
outputting signaling indicating that the estimate exceeds a defined contact force threshold.

9. The method according to claim 7, further comprising setting the defined contact force threshold according to a user-configured value.

10. The method according to claim 1, further comprising determining the prediction noise according to a prediction noise model corresponding to a torque prediction model used by the electronic control system to predict the expected torques.

11. The method according to claim 1, wherein the actuation involves at least a first movement of the robotic arm in which the robotic arm moves an end effector of the robotic arm in a first direction that is normal to and towards a placement surface, and wherein performing the contact force detection comprises detecting contact while moving in the first direction and terminating the first movement responsive to detecting the contact.

12. The method according to claim 11, wherein controlling the end effector responsive to the contact force detection comprises controlling the end effector to release the object responsive to detecting the contact in the first direction.

13. The method according to claim 11, wherein the actuation further involves a second movement in which the robotic arm moves the end effector in a plane parallel to the placement surface, the second movement being in a second direction in the parallel plane, and wherein performing the contact force detection further comprises detecting contact while moving in the second direction and terminating the second movement responsive to detecting the contact in the second direction.

14. The method according to claim 13, wherein controlling the end effector responsive to the contact force detection comprises controlling the end effector to release the object responsive to detecting the contact in the second direction.

15. The method according to claim 13, wherein the actuation further involves a third movement performed responsive to termination of the second movement, wherein, in the third movement, the robotic arm moves the end effector in the parallel plane, in a third direction that is at an angle relative to the second direction, and wherein performing the contact force detection further comprises detecting contact while moving in the third direction and terminating the third movement responsive to detecting the contact in the third direction.

16. The method according to claim 15, wherein controlling the end effector responsive to the contact force detection comprises controlling the end effector to release the object responsive to termination of the third movement.

17. The method according to claim 1, wherein predicting the expected torque with respect to each commanded torque is based on receiving joint angle and velocity information during the actuation of the robotic arm.

18. The method according to claim 1, wherein predicting the expected torque with respect to each commanded torque accounts for one or more of:
gravity-related torque at the respective joint; or
friction-related torque at the respective joint, and
wherein accounting for the friction-related torque comprises including determining whether coulomb friction is active for the respective joint, based on velocity information received for the respective joint, and using a temperature-related model for the friction-related torque, based on operating temperature information received for the respective joint.

19. An electronic control system configured to control actuation of a robotic arm, the electronic control system comprising:
interface circuitry configured to interface the electronic control system with the robotic arm; and
processing circuitry operatively associated with the interface circuitry and configured to:
generate torque commands for actuating the robotic arm, each torque command indicating a commanded torque for a corresponding joint actuator at a respective joint of the robotic arm, the commanded torque dependent on a presence or absence of an interfering external contact force;
predict an expected torque with respect to each commanded torque, such that there are corresponding pairs of commanded and expected torques, with the predicting presuming the absence of interfering external contact forces;
perform contact force detection during actuation of the robotic arm, by evaluating residual values against corresponding thresholds that account for prediction noise associated with predicting the expected torques; and
control an end effector of the robotic arm responsive to the contact force detection.

20. The electronic control system according to claim 19, wherein the processing circuitry is configured to output alert signaling or activating an alert indicator, responsive to determining that the prediction noise results in an undetectable contact force that exceeds a programmed threshold.

21. The electronic control system according to claim 19, wherein the processing circuitry is configured to terminate or modify the actuation of the robotic arm in response to the contact force detection indicating contact between the robotic arm and an external object.

22. The electronic control system according to claim 19, wherein, to perform the contact force detection and with respect to each residual value, the processing circuitry is configured to classify the robotic arm as being in either a contact state or a no-contact state, in dependence on whether the residual value exceeds a threshold that depends on the prediction noise.

23. The electronic control system according to claim 22, wherein the processing circuitry is further configured to initiate stoppage of the actuation of the robotic arm in response to the classifying indicating transition of the robotic arm from the no-contact state to the contact state.

24. The electronic control system according to claim 19, wherein the prediction noise is velocity dependent, such that the threshold used for each residual value depends on a joint velocity of the respective joint at a time corresponding to prediction of the expected torque on which the residual value is based.

25. The electronic control system according to claim 24, wherein the processing circuitry is configured to compute the prediction noise as a function of static friction, for joint velocities below a defined velocity threshold, and as a function of quantified modeling uncertainties in a torque prediction model used by the electronic control system, for joint velocities above the defined velocity threshold.
